(19) United States
(12) Patent Application Publication
(10) Pub. No.: US 2019/0144659 A1
(43) Pub. Date: May 16, 2019

(54) Flame Retardant Compositions For Polyolefins

(71) Applicants: Clariant Plastics & Coatings Ltd., Muttenz (CH); FRX Polymers Ltd., Chelmsford, MA (US)

(72) Inventors: Sebastian HÖROLD, Diedorf (DE); Toa WANG, Büron (CH); Jan-Pleun LENS, Reading, MA (US); Youmi JEONG, Boxborough, MA (US)

(73) Assignees: Clariant Plastics & Coatings Ltd., Muttenz (CH); FRX Polymers Ltd., Chelmsford, MA (US)

(21) Appl. No.: 16/189,191

(22) Filed: Nov. 13, 2018

Related U.S. Application Data
(60) Provisional application No. 62/585,253, filed on Nov. 13, 2017.

(51) Int. Cl. C08L 43/02; C08K 5/5333; C08K 5/3432; C08J 5/18; C08L 23/08; C08L 51/06

(52) U.S. Cl. CPC C08L 43/02; C08K 5/5333; C08K 5/3432; C08J 5/18; C08L 2201/02; C08L 51/06; C08J 2323/08; C08J 2433/12; C08K 2201/014; C08L 23/0869

(57) ABSTRACT

A flame-retardant composition is described as comprising phosphonate oligomers or polymers of formula (I) as a component (A)

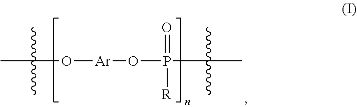

an amino ether of formula (II) as a component (B)

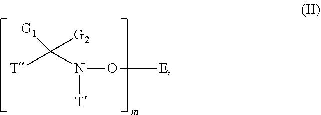

and a thermoplastic polymer as a component (C), where the components (A), (B) and (C) are as defined.

### FIELD

The invention relates to a composition including a thermoplastic polymer and a synergistic mixture of specific amino ethers and phosphonate oligomers, polymers, or copolymers.

The composition may be employed, in particular, as a flame retardant for thin-gauge materials, such as for polyolefin sheets and films and polyolefin fibers.

### BACKGROUND

Polyolefins are increasingly being employed in applications where flame retardancy is required. Flame retardancy is typically achieved by addition of bromine or phosphorus compounds. However, bromine compounds markedly reduce the photostability of the olefins and can therefore only be used to a very limited extent in exterior applications.

Phosphorus-containing flame retardants need to be employed in large amounts and are also often ineffective in thin-gauge applications such as fibers and sheets and films.

U.S. Pat. No. 6,599,963 describes polymeric substrates comprising a flame retardant system comprising a sterically hindered amine and a brominated flame retardant.

WO-A-1999/000450 describes the use of a sterically hindered amine compound as a flame retardant for polymers.

WO-A-2010/026230 describes mixtures of cyclic phosphonates, one or more 1,3,5-triazine compounds and sterically hindered amino ethers. Said document describes polyethylene sheets and films meeting the fire classification DIN 4102 B2. The disadvantage is that transparent sheets and films cannot be prepared. WO-A-2015/010775 claims the combination of amino ethers from sterically hindered amines together with a fine grained phosphinate salt. By the combination the flame retardancy can be much improved, but no transparent flame retarded films could be achieved.

WO-A-2011/117266 describes polymeric substances comprising a salt of a phosphinic acid and a tetraalkylpiperidine or a tetraalkylpiperazine derivative.

Polypropylene achieves fire classification V-2 with the addition of 8% flame retardant. The mixture is unsuitable for sheets and films and fibers due to the high filler content and the particle size of the phosphinic acid salt employed.

Owing to their chemical reactivity which is required for flame retardancy at high temperatures, flame retardants may impair the processing stability of plastic materials. Increased polymer degradation, crosslinking reactions, outgassing or discoloration may occur, for example. These effects occur in attenuated form, if at all, for plastic materials processing in the absence of said flame retardant.

The difficulty with incorporation of the sterically hindered amines described in WO-A-1999/000450 into sheets and films or fibers is that odor and/or discoloration problems are encountered during incorporation. Furthermore, compounds of low molecular weight may migrate out of the plastic material.

Polyphosphonates or phosphonate oligomers have shown flame retardant activity in a number of plastics as well. However, these polyphosphonates require high loadings in the thermoplastic resin, even with the addition of typical melamine based synergists (US-A-2009/0043013).

It is therefore an object of the present invention, for the aforementioned application, to provide innovative combinations of polyolefins and flame retardants that do not have the existing drawbacks of the current amino-ether based flame retardants, and that are superior in performance to the patented combinations known to date.

### SUMMARY

Some embodiments provide a composition comprising as component (A) phosphonate oligomers or polymers of formula (I)

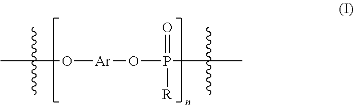

wherein:
Ar is an aromatic group;
R is a C₁-C₂₀-alkyl, C₂-C₂₀-alkene, C₂-C₂₀-alkyne, C₅-C₂₀-cycloalkyl or C₆-C₂₀-aryl;
n is an integer from 2 to 200;

—O—Ar—O— is derived from a compound selected from the group consisting of resorcinols, hydroquinones, and bisphenols, and combinations thereof; as component (B) an amino ether of formula (II),

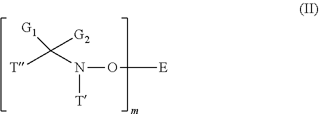

wherein
m may be less than or equal to the number of carbon atoms in E and
E is C₁- to C₁₀₀₀₀₀₀-alkyl or C₅-C₆-cycloalkyl, wherein the alkyl chain may comprise alkyl substituents, aromatic substituents and polar groups as substituents and may be interrupted by alkene units and/or heteroatoms;
wherein
G1 and G2 may be identical or different and independently of one another are hydrogen, halogen, NO₂, cyano, CONR₅R₆, (R₉)COOR₄, C(O)—R₇, OR₈, SR₈, NHR₈, N(R₁₈)₂, carbamoyl, di(C₁-C₁₈-alkyl)carbamoyl, C(═NR₅)(NHR₆), C₁-C₁₈-alkyl; C₃-C₁₈-alkenyl; C₃-C₁₈-alkynyl, C₇-C₉-phenylalkyl, C₃-C₁₂-cycloalkyl or C₂-C₁₂-heterocycloalkyl; C₂-C₁₈-alkyl interrupted by at least one O atom and/or by —NR₅—; C₆-C₁₀-aryl;
   phenyl or naphthyl, in each case substituted with C₁-C₄-alkyl, C₁-C₄-alkoxy, C₁-C₄-alkylthio, halogen, cyano, hydroxy, carboxy, COOR₂₁, C(O)—R₂₂, C₁-C₄-alkylamino or di(C₁-C₄-alkyl)amino;
or
G1 and G2 together with the carbon atom to which they are bonded form a C₃-C₁₂-ring;
T′ is hydrogen, a primary C₁-C₁₈-alkyl, a secondary C₃-C₁-alkyl, a tertiary C₄-C₁₈-alkyl or a phenyl group, each of which is unsubstituted or substituted with halogen, OH, COOR₂₁ or C(O)—R₂₂; or C₅-C₁₂-cycloalkyl or C₅-C₁₂-cycloalkyl interrupted by at least one O or —N(R₁₈)—; or a polycyclic alkyl radical having 7 to 18 carbon atoms, or the identical radical interrupted by at least one —O— or —N(R₁₈)—; or T′ is C-(G1)(G2)-T″;
T″ is hydrogen, halogen, NO₂, cyano or a monovalent organic radical having 1 to 50 carbon atoms; or T″ and T′ together form a divalent organic connecting group which, together with the sterically hindered amine nitrogen atom and the quaternary carbon atom substituted with G₁ and G₂, form an optionally substituted five- or six-membered ring structure, and
   R₄ is hydrogen, C₁-C₁₈-alkyl, phenyl, an alkali metal ion or a tetraalkylammonium cation;
   R₅ and R₆ are independently of each other hydrogen, C₁-C₁₈-alkyl, C₂-C₁₈-alkyl substituted with hydroxy or, taken together, form a C₂-C₁₂-alkylene bridge or a C₂-C₁₂-alkylene bridge interrupted by —O— or/and —N(R₁₈)—;
   R₇ is hydrogen, C₁-C₁₈-alkyl or C₆-C₁₀-aryl;
   R₈ is hydrogen, C₁-C₁₈-alkyl or C₂-C₁₈-hydroxyalkyl;
   R₉ is C₁-C₁₂-alkylene or a bond;
   R₁₈ is C₁-C₁₂-alkyl or phenyl, unsubstituted or substituted by halogen, OH, COOR₂₁ or C(O)—R₂₂;
   R₂₁ is hydrogen, an alkali metal atom or C₁-C₁₈-alkyl;
   R₂₂ is C₁-C₁₈-alkyl;
as component (C) a thermoplastic polymer;

and optional as component D a compatibilizer for the phosphonate oligomer or polymer and the thermoplastic polymer C.

In some embodiments, the group consisting of resorcinols, hydroquinones and bisphenols and combinations thereof includes bisphenol A, bisphenol F and 4,4′-biphenol, phenolphthalein and its derivatives, 4,4′-thiodiphenol, 4,4′-sulfonyldiphenol, 1,1-bis-(4-hydroxyphenyl)-3,3,5-trimethylcyclohexane, and combinations thereof.

In some embodiments, n in formula (I) is an integer equal 2 or greater than 2; in some embodiments, n in formula (I) is an integer from 2 to 100; in some embodiments, n in formula (I) is an integer from 2 to 50; in some embodiments, n in formula (I) is an integer from 2 to 20; and in some embodiments, n in formula (I) is an integer from 2 to 5.

In some embodiments, E is C₆₀- to C₁₀₀₀₀₀₀-alkyl.

In some embodiments, component B may be a reaction product of a fatty acid 2,2,6,6-tetramethylpiperidin-4-yl-hexadecanoate and 2,2,6,6-tetramethylpiperidin-4-yl-octadecanoate with an oxidized polyethylene of the formula

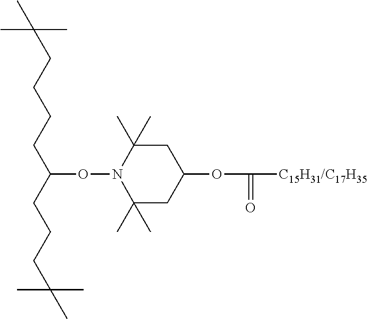

wherein

C₁₅H₃₁/C₁₇H₃₅ are the main components and the alkyl radical at the N—O— has an average molecular weight of about 2000.

In some embodiments, component D is a typical compatibilizer for polar and non-polar polymers consisting of bipolar molecules, e.g. maleic anhydride grafted polyolefins, glycidyl methacrylate grafted polyolefins, maleic anhydride-olefin copolymers, glycidyl methacrylate-olefin copolymers, maleic anhydride-acrylate-olefin terpolymers, glycidyl methacrylate-acrylate-olefin terpolymers, and/or maleic anhydride-acrylate copolymers, glycidyl methacrylate-acrylate copolymers.

In some embodiments, the composition comprises 0.2 to 10 wt. % of component (A), 0.1 to 5 wt. % of component (B) and 80 to 99.7 wt. % of component (C) and 0 to 5 wt. % of component D.

In some embodiments, the composition comprises 0.5 to 5 wt. % of component (A), 0.2 to 2 wt. % of component (B) and 90 to 99.3 wt. % of component (C) and 0 to 3 wt. % of component D.

In some embodiments, the composition comprises 0.2 to 2 wt. % of component (A), 0.5 to 2 wt. % of component (B) and 94 to 99.2 wt. % of component (C) and 0.1 to 2.0 wt. % of component D.

In some embodiments, the thermoplastic polymer is a polyolefin.

In some embodiments, the composition is processed into a transparent sheeting of 50-500 μm in thickness.

Some embodiments provide a molded article, film, sheet, or fiber produced with the compositions or compositions as described herein.

### DETAILED DESCRIPTION

Surprisingly, it has now been found that mixtures of amino ethers from sterically hindered amines with polyphosphonates or phosphonate oligomers show improved flame retardant action in polyolefins. Various flame retardant classifications can be achieved at low loadings, and the negative impact on physical properties is lessened.

The flame retarded polyolefin materials of the present invention also show very good transparency, UV resistance, flowability, extrudability and moldability.

The present invention thus relates to a composition comprising as component (A) phosphonate oligomers or polymers of formula (I)

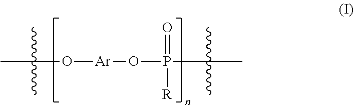

wherein:
Ar is an aromatic group;
R is a C₁-C₂₀-alkyl, C₂-C₂₀-alkene, C₂-C₂₀-alkyne, C₅-C₂₀-cycloalkyl or C₆-C₂₀-aryl;
n is an integer from 2 to 200;

—O—Ar—O— is derived from a compound selected from the group consisting of resorcinols, hydroquinones, and bisphenols, and combinations thereof; as component (B) an amino ether of formula (II),

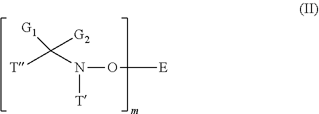

wherein
m may be less than or equal to the number of carbon atoms in E and
E is C₁- to C₁₀₀₀₀₀₀-alkyl or C₅-C₆-cycloalkyl, wherein the alkyl chain may comprise alkyl substituents, aromatic substituents and polar groups as substituents and may be interrupted by alkene units and/or heteroatoms;

wherein
G1 and G2 may be identical or different and independently of one another are hydrogen, halogen, NO₂, cyano, CONR₅R₆, (R₉)COOR₄, C(O)—R₇, OR₈, SR₈, NHR₈, N(R₁₈)₂, carbamoyl, di(C₁-C₁₈-alkyl)carbamoyl, C(═NR₅)(NHR₆), C₁-C₁₈-alkyl; C₃-C₁₈-alkenyl; C₃-C₁₈-alkynyl, C₇-C₉-phenylalkyl, C₃-C₁₂-cycloalkyl or C₂-C₁₂-heterocycloalkyl; C₂-C₁₈-alkyl interrupted by at least one O atom and/or by —NR₅—; C₆-C₁₀-aryl;
   phenyl or naphthyl, in each case substituted with C₁-C₄-alkyl, C₁-C₄-alkoxy, C₁-C₄-alkylthio, halogen, cyano, hydroxy, carboxy, COOR₂₁, C(O)—R₂₂, C₁-C₄-alkylamino or di(C₁-C₄-alkyl)amino;
or
G1 and G2 together with the carbon atom to which they are bonded form a C₃-C₁₂-ring;
T′ is hydrogen, a primary C₁-C₁₈-alkyl, a secondary C₃-C₁₈-alkyl, a tertiary C₄-C₁₈-alkyl or a phenyl group, each of which is unsubstituted or substituted with halogen, OH, COOR₂₁ or C(O)—R₂₂; or C₅-C₁₂-cycloalkyl or C₅-C₁₂-cycloalkyl interrupted by at least one O or —N(R₁₈)—; or a polycyclic alkyl radical having 7 to 18 carbon atoms, or the identical radical interrupted by at least one —O— or —N(R₁₈)—; or T′ is C-(G₁)(G2)-T″;
T″ is hydrogen, halogen, NO₂, cyano or a monovalent organic radical having 1 to 50 carbon atoms; or T″ and T′ together form a divalent organic connecting group which, together with the sterically hindered amine nitrogen atom and the quaternary carbon atom substituted with G₁ and G₂, form an optionally substituted five- or six-membered ring structure, and
   R₄ is hydrogen, C₁-C₁₈-alkyl, phenyl, an alkali metal ion or a tetraalkylammonium cation;
   R₅ and R₆ are independently of each other hydrogen, C₁-C₈-alkyl, C₂-C₁₈-alkyl substituted with hydroxy or, taken together, form a C₂-C₁₂-alkylene bridge or a C₂-C₁₂-alkylene bridge interrupted by —O— or/and —N(R₁₈)—;
   R₇ is hydrogen, C₁-C₁₈-alkyl or C₆-C₁₀-aryl;
   R₈ is hydrogen, C₁-C₁₈-alkyl or C₂-C₁₈-hydroxyalkyl;
   R₉ is C₁-C₁₂-alkylene or a bond;
   R₁₈ is C₁-C₁₂-alkyl or phenyl, unsubstituted or substituted by halogen, OH, COOR₂₁ or C(O)—R₂₂;
   R₂₁ is hydrogen, an alkali metal atom or C₁-C₈-alkyl;
   R₂₂ is C₁-C₁₈-alkyl;

as component (C) a thermoplastic polymer;

and optional as component D a compatibilizer for the phosphonate oligomer or polymer and the thermoplastic polymer C.

In some embodiments, the group consisting of resorcinols, hydroquinones and bisphenols and combinations thereof includes bisphenol A, bisphenol F and 4,4′-biphenol, phenolphthalein and its derivatives, 4,4′-thiodiphenol, 4,4′-sulfonyldiphenol, 1,1-bis-(4-hydroxyphenyl)-3,3,5-trimethylcyclohexane, and combinations thereof.

In some embodiments, n in formula (I) is an integer equal 2 or greater than 2; in some embodiments, n in formula (I) is an integer from 2 to 100; in some embodiments, n in formula (I) is an integer from 2 to 50; in some embodiments, n in formula (I) is an integer from 2 to 20; and in some embodiments, n in formula (I) is an integer from 2 to 5.

In some embodiments, E is C₆₀- to C₁₀₀₀₀₀₀-alkyl.

In some embodiments, component B may be a reaction product of a fatty acid 2,2,6,6-tetramethylpiperidin-4-yl-hexadecanoate and 2,2,6,6-tetramethylpiperidin-4-yl-octadecanoate with an oxidized polyethylene of the formula

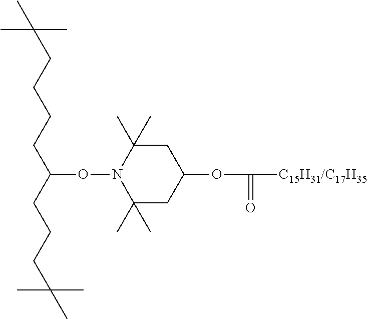

wherein

C₁₅H₃₁/C₁₇H₃₅ are the main components and the alkyl radical at the N—O— has an average molecular weight of about 2000.

In some embodiments, component D is a typical compatibilizer for polar and non-polar polymers consisting of bipolar molecules, e.g. maleic anhydride grafted polyolefins, glycidyl methacrylate grafted polyolefins, maleic anhydride-olefin copolymers, glycidyl methacrylate-olefin copolymers, maleic anhydride-acrylate-olefin terpolymers, glycidyl methacrylate-acrylate-olefin terpolymers, and/or maleic anhydride-acrylate copolymers, glycidyl methacrylate-acrylate copolymers.

In some embodiments, the composition comprises 0.2 to 10 wt. % of component (A), 0.1 to 5 wt. % of component (B) and 80 to 99.7 wt. % of component (C) and 0 to 5 wt. % of component D.

In some embodiments, the composition comprises 0.5 to 5 wt. % of component (A), 0.2 to 2 wt. % of component (B) and 90 to 99.3 wt. % of component (C) and 0 to 3 wt. % of component D.

In some embodiments, the composition comprises 0.2 to 2 wt. % of component (A), 0.5 to 2 wt. % of component (B) and 94 to 99.2 wt. % of component (C) and 0.1 to 2.0 wt. % of component D.

In some embodiments, the thermoplastic polymer is a polyolefin.

In some embodiments, the composition is processed into a transparent sheeting of 50-500 μm in thickness.

The invention includes various molded articles, films, sheets, or fibers made from the compositions described above.

Phosphonate oligomers and polymers, linear or branched, are well known in the literature. For example, see U.S. Pat. Nos. 7,449,526, 7,816,486, 8,530,044, 8,563,638, and 8,779,041.

In certain embodiments, the phosphonate component may be a polyphosphonate containing long chains of the structural unit of Formula I with n>20.

In some embodiments, the polyphosphonates may have a weight average molecular weight (Mw) of about 10,000 g/mole to about 150,000 g/mole as determined by gel permeation chromatography (GPC) based on polystyrene standards. In other embodiments, the polyphosphonates may have an Mw of from about 12,000 to about 80,000 g/mole as determined by GPC based on polystyrene standards.

The number average molecular weight (Mn) as determined by GPC based on polystyrene standards in such embodiments may be from about 5,000 g/mole to about 75,000 g/mole, or from about 8,000 g/mole to about 15,000 g/mole, and in certain embodiments the Mn may be greater than about 9,000 g/mole.

The molecular weight distribution (i.e., Mw/Mn) of such polyphosphonates may be from about 2 to about 10 in some embodiments and from about 2 to about 5 in other embodiments.

In certain embodiments, the phosphonate component may be a phosphonate oligomer containing structural units of Formula I and n is an integer from 2 to about 20, 2 to about 10, or 2 to about 5, or any integer between these ranges.

In some embodiments, the Mw as determined by GPC based on polystyrene calibration of the phosphonate oligomers may be from about 1,000 g/mole to about 10,000 g/mole or any value within this range.

In other embodiments, the Mw may be from about 1,500 g/mole to about 8,000 g/mole, about 2,000 g/mole to about 4,000 g/mole, or any value within these ranges.

The phosphorus content of the polyphosphonates and oligomeric phosphonates may vary among embodiments, and embodiments are not limited by the phosphorus content or range of phosphorus content. For example, in some embodiments, the oligomeric phosphonates may have a phosphorus content, of from about 1% to about 20% by weight of the total oligomer, and in other embodiments, the phosphorous content may be from about 2% to about 15% by weight of the total oligomer, about 2% to about 12% by weight of the total oligomer, or about 2% to about 10% by weight of the total oligomer.

In some embodiments the phosphonate oligomer or polymer may be branched or linear and may be prepared with up to about 50 mol % branching agent.

In certain embodiments, component B is a reaction product of a fatty acid 2,2,6,6-tetramethylpiperidin-4-yl-hexadecanoate and 2,2,6,6-tetramethylpiperidin-4-yl-octadecanoate with an oxidized polyethylene of the formula

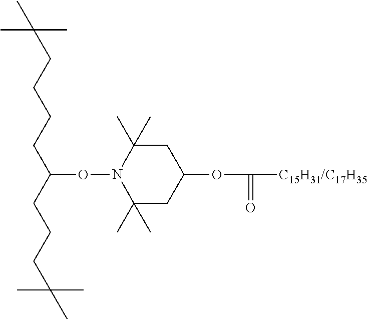

wherein

C_{15/17} are the main components and the alkyl radical at the N—O— has an average molecular weight of about 2000 (CAS No. 86403-32-9).

In some embodiments, E is C₅- to C₆-cycloalkyl.

In some embodiments, E is C₆₀- to C₁₀₀₀₀₀₀-alkyl.

In some embodiments, E is a wax.

Waxes are natural or synthetic materials which at 20° C. are solid and kneadable and above 40° C. melt without decomposition and have a low viscosity. Waxes undergo transition into the molten, low-viscosity state generally between 50° C. and 90° C. and in exceptional cases at up to about 200° C. A distinction is made between natural waxes such as carnauba wax, chemically modified waxes such as montan ester waxes and synthetic waxes such as polyethylene waxes.

The waxes can be hydrocarbon waxes, ester waxes, oxidized polyolefin waxes, oxidized hydrocarbon waxes, amide waxes, wax acids, wax soaps, natural waxes and/or combinations of these components.

Examples of suitable natural waxes include, but are not limited to, plant waxes such as carnauba or candelilla wax or waxes of animal origin, for example shellac wax.

It is also possible to use polar or nonpolar fully synthetic waxes, for example polyolefin waxes. Nonpolar polyolefin waxes may be produced by thermal degradation of branched or unbranched polyolefin plastics materials or by direct polymerization of olefins.

Polar polyolefin waxes are formed by appropriate modification of nonpolar waxes, for example by oxidation with air or by grafting on polar olefin monomers, for example α,β-unsaturated carboxylic acids and/or derivatives thereof, for instance acrylic acid or maleic anhydride.

Polar polyolefin waxes may further be prepared by copolymerization of ethylene with polar comonomers, for example vinyl acetate or acrylic acid, furthermore by oxidative degradation of relatively high molecular weight non-waxy ethylene homo- and copolymers. Corresponding examples may be found, for instance, in Ullmann's Encyclopedia of Industrial Chemistry, 5th Ed., Vol. A 28, Weinheim 1996, Ch. 6.1.5., page 155-156.

Suitable polyolefin waxes include degradation waxes prepared by thermal degradation of ethylene or 1-olefin homo- and copolymers, for example polyethylene or polypropylene.

Also suitable are polar waxes prepared by modification of the abovementioned polyolefin waxes. Modification is achieved by processes known per se, for example by oxidation with oxygen-containing gases, for example air, and/or by grafting with α,β-unsaturated acids or derivatives thereof, for example acrylic acid, acrylate esters, maleic anhydride, maleic acid.

It has now been found that, surprisingly, mixtures of phosphonate oligomers or polymers with amino ether compounds having the structure R—O—N where R is an alkyl group and N is a sterically hindered amine are very effective flame retardants in polyolefin sheets and films and the sheets and films are transparent and light-stable. The compounds are thermally stable, transparent and show no discoloration or odor problems on incorporation into polymers.

The terms “transparency,” “optical transparency,” transmittance, and “light transmission” used herein are intended to describe the amount of visible light (wavelength range approximately 300 nm to 700 nm) that can pass through the thickness of a given sample, usually presented in a percentage less than 100%.

The transparency is typically measured using a visible spectrophotometer by placing the sample in the light beam, and the amount of light that passes through is recorded. The transparent sheets and films of the current invention show a transparency of equal or larger than 50%.

The R—O—N compounds preferably have a high molecular weight and therefore show no propensity for migration out of the plastics materials.

Specifically, the present invention relates to the use of a synergistic mixture of phosphonate oligomers or polymers with amino ethers of formula D and D′ as a flame retardant and multifunctional additive,

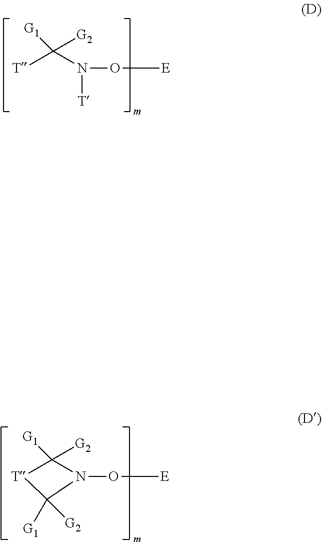

wherein m may be 1 to 50.

E is C₁- to C₁₀₀₀₀₀-alkyl or C₅- to C₆-cycloalkyl, wherein the alkyl chain may comprise alkyl substituents, aromatic substituents and polar groups as substituents.

The alkyl chain may also be interrupted by alkene units and heteroatoms.

Specific examples of amino ethers according to the invention are

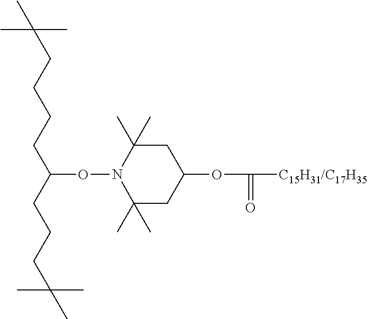

The amino ethers composed of wax (E) and sterically hindered amine are thermally stable and neither decompose the polymers during processing nor affect the production process of the plastic material molding compounds. The reaction products composed of wax and sterically hindered amine are not volatile under typical production and processing conditions for thermoplastic polymers and do not have a propensity for migration out of the plastics material.

Polymers that may be employed in accordance with the invention are thermoplastic polymers.

According to Hans Domininghaus in “Die Kunststoffe and ihre Eigenschaften”, 5^{th} Edition (1998), pages 14-25, thermoplastic polymers (component C) are to be understood as meaning polymers whose molecular chains have no side branchings or else varying numbers of side branchings of greater or lesser length and which soften when heated and are virtually infinitely moldable.

The polymers may be polymers of mono- and diolefins, for example polypropylene, polyisobutylene, polybutene-1, poly-4-methylpentene-1, polyisoprene or polybutadiene, and polymers of cycloolefins, for example of cyclopentene or norbornene; and also polyethylene (which may optionally be crosslinked), for example high-density polyethylene (HDPE), high-density, high-molecular-weight polyethylene (HDPE-HMW), high-density, ultrahigh-molecular-weight polyethylene (HDPE-UHMW), medium-density polyethylene (MDPE), low-density polyethylene (LDPE), linear low-density polyethylene (LLDPE), branched low-density polyethylene (BLDPE), and mixtures thereof.

The polymers may be copolymers of mono- and diolefins with one another or with other vinyl monomers, for example ethylene-propylene copolymers, linear low-density polyethylene (LLDPE) and mixtures thereof with low-density polyethylene (LDPE), propylene-butene-1 copolymers, propylene-isobutylene copolymers, ethylene-butene-1 copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers thereof with carbon monoxide, or ethylene-acrylic acid copolymers and salts thereof (ionomers), and also terpolymers of ethylene with propylene and a diene such as hexadiene, dicyclopentadiene or ethylidenenorbornene; and also mixtures of such copolymers with one another, for example polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers and alternating or random polyalkylene/carbon monoxide copolymers and mixtures thereof with other polymers, for example polyamides.

The polymers may be hydrocarbon resins (for example C₆- to C₉), including hydrogenated modifications thereof (for example tackifier resins) and mixtures of polyalkylenes and starch.

The polymers may be polystyrene (Polystyrol® 143E (BASF), poly(p-methylstyrene), poly(alpha-methylstyrene).

The polymers may be copolymers of styrene or alpha-methylstyrene with dienes or acrylic derivatives, for example styrene-butadiene, styrene-acrylonitrile, styrene-alkyl methacrylate, styrene-butadiene-alkyl acrylate and methacrylate, styrene-maleic anhydride, styrene-acrylonitrile-methyl acrylate; high impact resistance mixtures of styrene copolymers and another polymer, for example a polyacrylate, a diene polymer or an ethylene-propylene-diene terpolymer; and block copolymers of styrene, for example styrene-butadiene-styrene, styrene-isoprene-styrene, styrene-ethylene/butylene-styrene or styrene-ethylene/propylene-styrene.

The polymers may be graft copolymers of styrene or alpha-methylstyrene, for example styrene on polybutadiene, styrene on polybutadiene-styrene or polybutadiene-acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene, styrene and alkyl acrylates/alkyl methacrylates on polybutadiene, styrene and acrylonitrile on ethylene-propylene-diene terpolymers, styrene and acrylonitrile on polyalkyl acrylates or polyalkyl methacrylates, styrene and acrylonitrile on acrylate-butadiene copolymers, and mixtures thereof, such as are known, for example, as ABS, MBS, ASA or AES polymers.

The polymers may be halogenated polymers, for example polychloroprene, chlorine rubber, chlorinated and brominated copolymer of isobutylene-isoprene (halobutyl rubber), chlorinated or chlorosulfonated polyethylene, copolymers of ethylene and chlorinated ethylene, epichlorohydrin homo- and copolymers, especially polymers of halogenated vinyl compounds, for example polyvinyl chloride, polyvinylidene chloride, polyvinyl fluoride, polyvinylidene fluoride; and copolymers thereof, such as vinyl chloride-vinylidene chloride, vinyl chloride-vinyl acetate or vinylidene chloride-vinyl acetate.

The polymers may be polymers deriving from alpha, beta-unsaturated acids and derivatives thereof, such as polyacrylates and polymethacrylates, butyl acrylate-impact-modifed polymethyl methacrylates, polyacrylam ides and polyacrylonitriles and copolymers of the cited monomers with one another or with other unsaturated monomers, for example acrylonitrile-butadiene copolymers, acrylonitrile-alkyl acrylate copolymers, acrylonitrile-alkoxyalkyl acrylate copolymers, acrylonitrile-vinyl halide copolymers or acrylonitrile-alkyl methacrylate-butadiene terpolymers.

The polymers may be polymers deriving from unsaturated alcohols and amines/from the acyl derivatives or acetals thereof, such as polyvinyl alcohol, polyvinyl acetate, stearate, benzoate or maleate, polyvinyl butyral, polyallyl phthalate, polyallylmelamine; and copolymers thereof with olefins.

The polymers may be homo- and copolymers of cyclic ethers, such as polyalkylene glycols, polyethylene oxide, polypropylene oxide or copolymers thereof with bisglycidyl ethers.

The polymers may be polyacetals, such as polyoxymethylene, and those polyoxymethylenes which comprise comonomers, for example ethylene oxide; polyacetals modified with thermoplastic polyurethanes, acrylates or MBS.

The polymers are preferably polyphenylene oxides and sulfides and mixtures thereof with styrene polymers or polyamides.

The polymers may be polyurethanes deriving from polyethers, polyesters and polybutadienes having both terminal hydroxyl groups and aliphatic or aromatic polyisocyanates, and the precursors thereof.

The polymers may be polyamides and copolyamides deriving from diamines and dicarboxylic acids and/or from aminocarboxylic acids or the corresponding lactams, such as polyamide 6 (polycaprolactam, poly-6-aminohexanoic acid, Nylon® 6, DuPont, Akulon® K122, DSM; Zytel® 7301, DuPont; Durethan® B 29, Bayer) and polyamide 6/6 (poly(N,N′-hexamethyleneadipamide), Nylon® 6/6, DuPont, Zytel® 101, DuPont; Durethan® A30, Durethan® AKV, Durethan® AM, Bayer; Ultramid® A3, BASF),

Block copolymers of the above polyamides with polyolefins, olefin copolymers, ionomers or chemically bonded or grafted elastomers; or with polyethers, for example with polyethylene glycol, polypropylene glycol or polytetramethylene glycol. Furthermore, EPDM- or ABS-modified polyam ides or copolyamides; and polyamides condensed during processing (“RIM polyamide systems”).

The polymers may be polyureas, polyim ides, polyamidimides, polyetherim ides, polyesterim ides, polyhydantoins and polybenzimidazoles.

The polymers are preferably polyesters deriving from dicarboxylic acids and dialcohols and/or from hydroxycarboxylic acids or the corresponding lactones, such as polyethylene terephthalate, polybutylene terephthalate (Celanex® 2500, Celanex® 2002, Celanese; Ultradur®, BASF), poly-1,4-dimethylolcyclohexane terephthalate, polyhydroxybenzoates, and block polyether esters deriving from polyethers with hydroxyl end groups; furthermore, polyesters modified with polycarbonates or MBS.

The polymers may be polycarbonates and polyester carbonates.

The polymers may be polysulfones, polyether sulfones and polyether ketones.

The polymers may be mixtures (polyblends) of the abovementioned polymers, for example PP/EPDM (polypropylene/ethylene-propylene-diene rubber), polyamide/EPDM or ABS (polyamide/ethylene-propylene-diene rubber or acrylonitrile-butadiene-styrene), PVC/EVA (polyvinyl chloride/ethylene-vinyl acetate), PVC/ABS (polyvinyl chloride/acrylonitrile-butadiene-styrene), PVC/MBS (polyvinyl chloride/methacrylate-butadiene-styrene), PC/ABS (polycarbonate/acrylonitrile-butadiene-styrene), PBTP/ABS (polybutylene terephthalate/acrylonitrile-butadiene-styrene), PC/ASA (polycarbonate/acrylic ester-styrene-acrylonitrile), PC/PBT (polycarbonate/polybutylene terephthalate), PVC/CPE (polyvinyl chloride/chlorinated polyethylene), PVC/acrylate (polyvinyl chloride/acrylate, POM/thermoplastic PUR (polyoxymethylene/thermoplastic polyurethane), PC/thermoplastic PUR (polycarbonate/thermoplastic polyurethane), POM/acrylate (polyoxymethylene/acrylate), POM/MBS (polyoxymethylene/methacrylate-butadiene-styrene), PPO/HIPS (polyphenylene oxide/high-impact polystyrene), PPO/PA 6,6 (polyphenylene oxide/nylon 6,6) and copolymers, PA/HDPE (polyamide/high-density polyethylene), PA/PP (polyamide/polyethylene), PA/PPO (polyamide/polyphenylene oxide), PBT/PC/ABS (polybutylene terephthalate/polycarbonate/acrylonitrile-butadiene-styrene) and/or PBT/PET/PC (polybutylene terephthalate/polyethylene terephthalate/polycarbonate).

The polymeric molded articles, films, threads and fibers are characterized in that polyolefins such as polyethylene, polypropylene, ethylene-vinyl acetate are concerned.

The polymeric films are characterized in that they are transparent.

Processing comprises premixing the components A and B and optional component D as powder and/or pellets in a mixer and subsequently homogenizing said components in the polymer melt (corresponding to component C) in a compounding apparatus (for example a twin-screwed extruder). The melt is typically extruded, cooled and pelletized. The components A, B, and optionally D may also be introduced directly into the compounding apparatus separately via a metering unit.

It is likewise possible to admix the components A and B and optional component D with prepared polymer pellets/powder (component C) and to process the mixture directly, for example on a film blowing line or a fiber spinning line.

Further additives can be added to the blends. The additives may be antioxidants, antistats, blowing agents, further flame retardants, heat stabilizers, impact modifiers, processing aids, glidants, light stabilizers, anti-drip agents, further compatibilizers, reinforcers, fillers, nucleating agents, additives for laser marking, hydrolysis stabilizers, chain extenders, pigments, softeners and/or plasticizers.

The flame retardant plastics material molding compounds are suitable for producing molded articles, films and sheets, threads and fibers, for example by injection molding, extrusion, blow molding, or press molding.

The compositions according to the invention are particularly suitable for blown films. Blown films feature an extraordinarily high film cohesion and particularly high perforation and tear propagation resistance. There are sheets and films composed of only one layer (so-called monolayer blown film) and sheets and films manufactured from a plurality of layers (so-called coextruded blown film). A coextruded blown film provides for combining the positive properties of different materials in one sheeting.

### EXAMPLES

Employed Inventive Materials

Component A

Nofia® HM1100: Polyphosphonate with phosphorus content of about 10.5 wt %; transparent, high flowing polymer with a glass transition temperature of about 105° C., supplier: FRX Polymers, Chelmsford, Mass. (USA).

Nofia® HM7000: Polyphosphonate with phosphorus content of about 10.5 wt %; lower molecular weight than HM1100, transparent, high flowing polymer, supplier: FRX Polymers, Chelmsford, Mass. (USA).

Nofia® HM5000: Polyphosphonate with phosphorus content of about 10.5 wt %; lower molecular weight than HM 7000, transparent, high flowing polymer, supplier: FRX Polymers, Chelmsford, Mass. (USA).

Component B

Hostavin® NOW: 2,2,6,6-tetramethylpiperidin-4-yl-hexadecanoate and 2,2,6,6-tetramethylpiperidin-4-yl-octadecanoate, reaction product with an oxidized polyethylene wax, Clariant, Frankfurt, DE, referred to hereinbelow as HALS-NO wax.

Flamestab® NOR 116: 1,3-propanediamine, N,N″-1,2-ethandiylbis, reaction product with cyclohexane and the peroxidized N-butyl-2,2,6,6-tetramethyl-4-piperidinamine-2,4,6-trichloro-1,3,5-triazine reaction product, CAS No. 191680-81-6, from BASF, Ludwigshafen, DE

Component C

Sabic LDPE 2102 Z 500, low-density polyethylene, MFR 1.7-2.2 g/10 min, from Sabic, Geleen, the Netherlands, referred to hereinbelow as LDPE

Component D

Licocene® PE MA 4351 from Clariant, Frankfurt, DE

Elvaloy® PTW, MSA grafted polyolefine, DuPont, USA

Lotader® AX 8800, glycidyl-methacrylate, Arkema, F

For comparative examples:

Exolit® OP 935, aluminum salt of diethylphosphinic acid, referred to hereinbelow as Depal d50 2-3 μm, particle size d95<10 μm, particle size d50 2-3 μm, Clariant, Frankfurt, DE.

Aflammit® PCO 800: melamine salt of a phosphonic acid, Thor, Speyer, DE.

Mixing of the polymer (component C) and the additives (components A, B and others) was performed in an Arenz KL 1 single-screw extruder at a temperature of 180-210° C. at 100 rpm.

The production of blown films of 50-200 μm in thickness was performed on a Collin BL 180/400 blown film line at 160-200° C.

Determination of the low flammability of the sheets and films was performed according to DIN 4102 B2 with test specimens having dimensions of 190*90 mm which are vertically clamped and subjected to flame exposure at their lower edge with 20 mm-high flames from a gas burner for 15 seconds. The test is passed if over a period of 20 seconds the tip of the flames does not reach a reference mark on the test specimens which is disposed at a distance of 150 mm from the flame-exposed lower edge.

The films were ignited in the test length wise and across the film extrusion. Transparency of the films is determined in neutral-grey light using a LT 12 transparency measure unit from Dr. Lange, Neuss, Germany. Calibration is done without sample at 100%, a grey filter is used.

TABLE 1
LDPE films 200 μm with amino ether and polymeric phosphonate

| | Example | | | | | | |
|---|---|---|---|---|---|---|---|
| | CE 1 | CE 2 | CE 3 | Ex. 1 | Ex. 2 | CE 4 | CE 5 |
| LDPE | 98 | 98 | 98 | 98 | 98 | 99 | 99 |
| HALS-NO wax | 2 | | | 1 | | | |
| Nofia HM1100 | | 2 | | 1 | 1 | 1 | |
| Flamestab NOR116 | | | 2 | | 1 | | 1 |
| DIN 4102 fire test | | | | | | | |
| B2 longitudinal | No | No | Yes | Yes | Yes | No | No |
| B2 crosswise | No | No | No | Yes | Yes | No | No |

Only with the combination of Nofia HM1100 and an amino ether flame retardant DIN 4102 B2 can be passed lengthwise and across the extrusion direction of the films. In addition, the films according to the present invention show good transparency and no colour shift. No odour was observed during processing of the films.

TABLE 2
LDPE films 50, 100 and 200 μm with amino ether and polymeric
phosphonate

| | Example | | | | | |
|---|---|---|---|---|---|---|
| | CE 6 | CE 7 | CE 8 | Ex. 1 | Ex. 3 | Ex. 4 |
| LDPE | 100 | 98 | 98 | 98 | 98 | 98 |
| Exolit OP 935 | | 1 | | | | |
| Aflammit PCO 800 | | | 1 | | | |
| HALS-NO wax | | 1 | 1 | 1 | 0.5 | 1.5 |
| Nofia HM1100 | | | | 1 | 1.5 | 0.5 |
| Transmittance | Yes | No | No | Yes | Yes | Yes |
| 200 μm film [% T] | 88 | 43 | 39 | 60 | 55 | 65 |
| DIN 4102 B2 | no | yes | yes | yes | yes | yes |
| longitudinal 50 μm | | | | | | |
| DIN 4102 B2 crosswise | no | yes | no | yes | yes | yes |
| 50 μm | | | | | | |
| DIN 4102 B2 | no | yes | yes | yes | yes | yes |
| longitudinal 100 μm | | | | | | |
| DIN 4102 B2 crosswise | no | yes | no | yes | yes | yes |
| 100 μm | | | | | | |
| DIN 4102 B2 | no | no | yes | yes | no | no |
| longitudinal 200 μm | | | | | | |
| DIN 4102 B2 crosswise | no | yes | yes | yes | no | yes |
| 200 μm | | | | | | |

CE 7 = comparative example according to WO-A-2015/010775
CE 8 = comparative example according to WO-A-2010/026230

Table 2 compares the inventive combination of phosphonate polymer and amino ether with a combination of phosphinate salt and non-polymeric phosphonate and with an amino ether. Transparent sheets and films are obtained only through the inventive combination of phosphonate polymer with amino ether. Table 3 shows that transparency can be further increased by adding a compatibilizer to the films. Employing HALS-NO wax further prevents discoloration and unpleasant odor during processing.

TABLE 3
Transparency of LDPE films 200 μm

Example

| | CE 6 | Ex. 1 | Ex. 5 | Ex. 6 |
|---|---|---|---|---|
| LDPE | 100 | 98 | 97 | 96 |
| Licocene PE MA4351 | | | 1 | 1 |
| Nofia HM-1100 | | 1 | 1 | 1 |
| HALS-NO wax | | 1 | 1 | 2 |
| Transmittance 200 μm [% T] | 88 | 60 | 74 | 68 |

The haze number is a measure for clouding of the sheets and films. The inventive combinations of NOR HALS with phosphonate polymers show markedly lower clouding values compared to the comparative examples. The sheets and films according to the present invention show improved mechanical properties (tensile test). The transparency of the sheets and films is markedly higher than with standard material.

TABLE 4
Transparency of LDPE films 200 μm with further compatibilizers

Example

| | CE 6 | Ex. 1 | Ex. 7 | Ex. 8 |
|---|---|---|---|---|
| LDPE | 100 | 98 | 97 | 97 |
| Elvaloy PTW | | | 1 | |
| Lotader AX 8800 | | | | 1 |
| Nofia HM-1100 | | 1 | 1 | 1 |
| HALS-NO wax | | 1 | 1 | 1 |
| Transmittance 200 μm [% T] | 88 | 60 | 78 | 72 |

TABLE 5
Transparency of LDPE films 200 μm with further compatibilizers

| | Example | | | |
|---|---|---|---|---|
| | CE 6 | Ex. 1 | Ex. 9 | Ex. 10 |
| LDPE | 100 | 98 | 97 | 97 |
| Elvaloy PTW | | | 1 | 1 |
| Nofia HM 5000 | | | 1 | |
| Nofia HM-7000 | | | | 1 |
| Nofia HM 1100 | | 1 | | |
| HALS-NO wax | | 1 | 1 | 1 |
| Transmittance 200 μm [% T] | 88 | 60 | 74 | 73 |

1. A composition comprising:
phosphonate oligomers or polymers of formula (I) as a component (A) 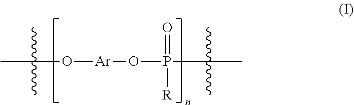
wherein:
Ar is an aromatic group;
R is a C₁-C₂₀-alkyl, C₂-C₂₀-alkene, C₂-C₂₀-alkyne, C₅-C₂₀-cycloalkyl or C₆-C₂₀-aryl;
n is an integer from 2 to 200;
—O—Ar—O— is derived from a compound selected from the group consisting of resorcinols, hydroquinones, and bisphenols, and combinations thereof;
an amino ether of formula (II) as a component (B) 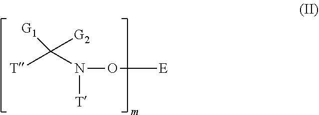
wherein:
m may be less than or equal to the number of carbon atoms in E and
E is C₁- to C₁₀₀₀₀₀₀-alkyl or C₅-C₆-cycloalkyl, wherein the alkyl chain may comprise alkyl substituents, aromatic substituents and polar groups as substituents and may be interrupted by alkene units and/or heteroatoms;
G₁ and G₂ may be identical or different and independently of one another are hydrogen, halogen, NO₂, cyano, CONR₅R₆, (R₉)COOR₄, C(O)—R₇, OR₈, SR₈, NHR₈, N(R₁₈)₂, carbamoyl, di(C₁-C₁₈-alkyl)carbamoyl, C(═NR₅)(NHR₆), C₁-C₁₈-alkyl; C₃-C₁₈-alkenyl; C₃-C₁₈-alkynyl, C₇—C-phenylalkyl, C₃-C₁₂-cycloalkyl or C₂-C₁₂-heterocycloalkyl; C₂-C₁₈-alkyl interrupted by at least one O atom and/or by —NR₅—; C₆-C₁₀-aryl; phenyl or naphthyl, in each case substituted with C₁-C₄-alkyl, C₁-C₄-alkoxy, C₁-C₄-alkylthio, halogen, cyano, hydroxy, carboxy, COOR₂₁, C(O)—R₂₂, C₁-C₄-alkylamino or di(C₁-C₄-alkyl)amino; or G₁ and G₂ together with the carbon atom to which they are bonded form a C₃-C₁₂-ring;
T′ is hydrogen, a primary C₁-C₁₈-alkyl, a secondary C₃-C₁₈-alkyl, a tertiary C₄-C₁₈-alkyl or a phenyl group, each of which is unsubstituted or substituted with halogen, OH, COOR₂₁ or C(O)—R₂₂; or C₅-C₁₂-cycloalkyl or C₅-C₁₂-cycloalkyl interrupted by at least one O or —N(R₁₈)—; or a polycyclic alkyl radical having 7 to 18 carbon atoms, or the identical radical interrupted by at least one —O— or —N(R₁₈)—; or T′ is C-(G₁)(G₂)-T″;
T″ is hydrogen, halogen, NO₂, cyano or a monovalent organic radical having 1 to 50 carbon atoms; or T″ and T′ together form a divalent organic connecting group which, together with the sterically hindered amine nitrogen atom and the quaternary carbon atom substituted with G₁ and G₂, form an optionally substituted five- or six-membered ring structure, and
R₄ is hydrogen, C₁-C₁₃-alkyl, phenyl, an alkali metal ion or a tetraalkylammonium cation;
R₅ and R₆ are independently of each other hydrogen, C₁-C₁₃-alkyl, C₂-C₁₈-alkyl substituted with hydroxy or, taken together, form a C₂-C₁₂-alkylene bridge or a C₂-C₁₂-alkylene bridge interrupted by —O— or/and —N(R₁₈)—;
R₇ is hydrogen, C₁-C₁₈-alkyl or C₅-C₁₀-aryl;
R₈ is hydrogen, C₁-C₁₈-alkyl or C₂-C₁₈-hydroxyalkyl;
R₉ is C₁-C₁₂-alkylene or a bond;
R₁₈ is C₁-C₁₂-alkyl or phenyl, unsubstituted or substituted by halogen, OH, COOR₂₁ or C(O)—R₂₂;
R₂₁ is hydrogen, an alkali metal atom or C₁-C₁₈-alkyl;
R₂₂ is C₁-C₁₈-alkyl; and
a thermoplastic polymer as a component (C).

2. The composition as claimed in claim 1 further comprising a compatibilizer as a component D.

3. The composition as claimed in claim 1, wherein the group consisting of resorcinols, hydroquinones, bisphenols, and combinations thereof includes bisphenol A, bisphenol F and 4,4′-biphenol, phenolphthalein and its derivatives, 4,4′-thiodiphenol, 4,4′-sulfonyldiphenol, 1,1-bis-(4-hydroxyphenyl)-3,3,5-trimethylcyclohexane, and combinations thereof.

4. The composition as claimed in claim 1, wherein E is C₆₀- to C₁₀₀₀₀₀-alkyl.

5. The composition as claimed in claim 1, wherein component B is a reaction product of a fatty acid 2,2,6,6-tetramethylpiperidin-4-yl-hexadecanoate and 2,2,6,6-tetramethylpiperidin-4-yl-octadecanoate with an oxidized polyethylene of the formula 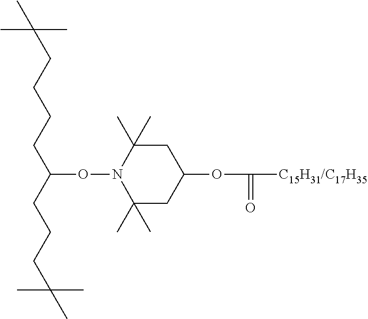
wherein C_{15/17} are main components and an alkyl radical at N—O— has an average molecular weight of about 2000.

6. The composition as claimed in claim 1, wherein n in formula (I) is an integer from 2 to 100.

7. The composition as claimed in claim 1, wherein n in formula (I) is an integer from 2 to 50.

8. The composition as claimed in claim 1, wherein n in formula (I) is an integer from 2 to 20.

9. The composition as claimed in claim 1, wherein n in formula (I) is an integer from 2 to 5.

10. The composition as claimed in claim 2, wherein component D is selected from the group consisting of maleic anhydride grafted polyolefins, glycidyl methacrylate grafted polyolefins, maleic anhydride-olefin copolymers, glycidyl methacrylate-olefin copolymers, maleic anhydride-acrylate-olefin terpolymers, glycidyl methacrylate-acrylate-olefin terpolymers, maleic anhydride-acrylate copolymers, and glycidyl methacrylate-acrylate copolymers.

11. The composition as claimed in claim 2, wherein the composition comprises 0.2 to 10 wt. % of component (A), 0.1 to 5 wt. % of component (B), 80 to 99.7 wt. % of component (C) and 0 to 5 wt. % of component (D).

12. The composition as claimed in claim 2, wherein the composition comprises 0.5 to 5 wt. % of component (A), 0.2 to 2 wt. % of component (B), 90 to 99.3 wt. % of component (C) and 0 to 3 wt. % of component (D).

13. The composition as claimed in claim 2, wherein the composition comprises 0.2 to 2 wt. % of component (A), 0.5 to 2 wt. % of component (B), 94 to 99.2 wt. % of component (C) and 0.1 to 2.0 wt. % of Component (D).

14. The composition as claimed in claim 1, wherein the thermoplastic polymer is a polyolefin.

15. The composition as claimed in claim 1, wherein the composition is processed into a transparent sheet or film of 50-500 μm in thickness.

16. A molded article, film or fiber produced with the composition as claimed in claim 1.
